(19) United States
(12) Patent Application Publication
(10) Pub. No.: US 2022/0335666 A1
(43) Pub. Date: Oct. 20, 2022

(54) METHOD AND APPARATUS FOR POINT CLOUD DATA PROCESSING, ELECTRONIC DEVICE AND COMPUTER STORAGE MEDIUM

(71) Applicant: SENSETIME INTERNATIONAL PTE. LTD., Singapore (SG)

(72) Inventors: Zhongang CAI, Singapore (SG); Xinyi CHEN, Singapore (SG); Junzhe ZHANG, Singapore (SG); Haiyu ZHAO, Singapore (SG); Shuai YI, Singapore (SG)

(21) Appl. No.: 17/364,248

(22) Filed: Jun. 30, 2021

Related U.S. Application Data
(63) Continuation of application No. PCT/IB2021/054753, filed on May 31, 2021.

(30) Foreign Application Priority Data
Apr. 15, 2021 (SG) 10202103896Y

(51) Int. Cl. G06T 11/00; G06K 9/46; G06T 9/00

(52) U.S. Cl. CPC G06T 11/006; G06K 9/46; G06T 9/00

(57) ABSTRACT

Disclosed is a method and apparatus for point cloud data processing, an electronic device and a computer storage medium. For each of multiple data points of first point cloud data, initial feature information of a respective one of the multiple data points and initial feature information of each of multiple neighboring points of the respective data point taken as a center point are acquired; correlation degree information between the respective data point and the multiple neighboring points is determined based on the initial feature information of the respective data point and the initial feature information of each of the multiple neighboring points; first target feature information of the respective data point is determined based on the correlation degree information; and point cloud data reconstruction is performed based on the first target feature information of each of the multiple data points to obtain second point cloud data.

### CROSS REFERENCE TO RELATED APPLICATIONS

This is continuation of International Patent Application No. PCT/IB2021/054753, filed on May 31, 2021, and entitled “METHOD AND APPARATUS FOR POINT CLOUD DATA PROCESSING, ELECTRONIC DEVICE AND COMPUTER STORAGE MEDIUM”, which is based upon and claim priority to Singapore Patent Application 10202103896Y, filed on Apr. 15, 2021, and entitled “METHOD AND APPARATUS FOR POINT CLOUD DATA PROCESSING, ELECTRONIC DEVICE AND COMPUTER STORAGE MEDIUM”. The disclosures of International Patent Application No. PCT/IB2021/054753 and Singapore Patent Application 10202103896Y are incorporated herein in their entireties for all purposes.

### TECHNICAL FIELD

Embodiments of the disclosure relate, but are not limited, to the technical field of machine learning, and particularly to a method and apparatus for point cloud data processing, an electronic device and a computer storage medium.

### BACKGROUND

A laser radar or a depth camera may be deployed in various types of scenes such as a monitoring scene and a shooting scene to collect point cloud data. A point cloud, as supplementary data of an image, may be adopted to acquire more real scene information.

However, compared with two-dimensional image information, point cloud data collected through a laser radar or a depth camera has the problems of sparsity, disorder and loss of part of a shape, etc., bringing difficulties in processing of the point cloud data.

How to perform reconstruction of point cloud data is a hot topic in researches of machine learning.

### SUMMARY

The embodiments of the disclosure provide a method and apparatus for point cloud data processing, an electronic device and a computer storage medium.

A first aspect provides a method for point cloud data processing, which may include the following operations. For each of multiple data points of first point cloud data, initial feature information of a respective one of the multiple data points and initial feature information of each of multiple neighboring points of the respective data point taken as a center point are acquired; correlation degree information between the respective data point and the multiple neighboring points is determined based on the initial feature information of the respective data point and the initial feature information of each of the multiple neighboring points; first target feature information of the respective data point is determined based on the correlation degree information between the respective data point and the multiple neighboring points; and point cloud data reconstruction is performed based on the first target feature information of each of the multiple data points to obtain second point cloud data.

A second aspect provides an apparatus for point cloud data processing, which may include: an acquisition unit, configured to, for each of multiple data points of first point cloud data, acquire initial feature information of a respective one of the multiple data points of the first point cloud data and initial feature information of each of multiple neighboring points of the respective data point taken as a center point; a first determination unit, configured to determine correlation degree information between the respective data point and the corresponding multiple neighboring points based on the initial feature information of the respective data point and the initial feature information of the corresponding multiple neighboring points; a second determination unit, configured to determine first target feature information of the respective data point based on the correlation degree information between the respective data point and the corresponding multiple neighboring points; and a reconstruction unit, configured to perform point cloud data reconstruction based on the first target feature information of each of the multiple data points to obtain second point cloud data.

A third aspect provides an electronic device, which may include a memory and a processor. The memory may store a computer program capable of running in the processor. The processor may execute the computer program to implement the steps in the method.

A fourth aspect provides a computer storage medium, which may store one or more programs. The one or more programs may be executed by one or more processors to implement the steps in the method.

### BRIEF DESCRIPTION OF THE DRAWINGS

In order to describe the technical solutions of the embodiments of the disclosure more clearly, the drawings required to be used in descriptions about the embodiments or a conventional art will be simply introduced below. It is apparent that the drawings described below are only some embodiments of the disclosure. Other drawings may further be obtained by those of ordinary skill in the art according to these drawings without creative work.

FIG. 1 is a structure diagram of a monitoring and alarming system according to an embodiment of the disclosure.

FIG. 2 is an implementation flowchart of a method for point cloud data processing according to an embodiment of the disclosure.

FIG. 3 is an implementation flowchart of another method for point cloud data processing according to an embodiment of the disclosure.

FIG. 4 is an implementation flowchart of another method for point cloud data processing according to an embodiment of the disclosure.

FIG. 5 is an implementation flowchart of another method for point cloud data processing according to an embodiment of the disclosure.

FIG. 6 is an implementation flowchart of a method for point cloud data processing according to another embodiment of the disclosure.

FIG. 7 is an implementation flowchart of a method for point cloud data processing according to another embodiment of the disclosure.

FIG. 8 is a schematic diagram of an architecture of a Point Self-Attention (PSA) kernel according to an embodiment of the disclosure.

FIG. 9 is a schematic diagram of an architecture of a target point kernel according to an embodiment of the disclosure.

FIG. 10 is a structure diagram of a relation improvement network according to an embodiment of the disclosure.

FIG. 11 is a structure diagram of an apparatus for point cloud data processing according to an embodiment of the disclosure.

FIG. 12 is a schematic diagram of a hardware entity of an electronic device according to an embodiment of the disclosure.

### DETAILED DESCRIPTION

The technical solutions of the disclosure will be specifically described below through the embodiments and in combination with the drawings in detail. The following specific embodiments may be combined. The same or similar concepts or processes will not be elaborated in some embodiments.

It is to be noted that, in the embodiments of the disclosure, “first”, “second” and the like are adopted to distinguish similar objects and not intended to describe a target sequence or order. In addition, the technical solutions recorded in the embodiments of the disclosure may be freely combined without conflicts.

The method for point cloud data processing provided by the embodiments of the present disclosure can be applied to scenarios of a recreation ground or a casino. In a recreation ground or casino scenario, multiple betting areas can be arranged on the gaming table. Players should bet in accordance with the rules of the game, and the dealer should take away or pay for the chips in accordance with the rules of collection. For example, gamers (including players or a banker) can place chips in the betting area. After the game result comes out, if a certain betting area represents the area where a player wins chips, then the dealer will pay for the chips in the betting area, if a certain betting area represents the area where a player loses chips, then the dealer will take away the chips in the betting area. For another example, in order to ensure the fairness of the game, after the game result comes out, the player will not be allowed to change the chips in the betting area, for example, the player is not allowed to add chips in the area that represents the player wins chips, or reduce chips in the area that represents the player loses chips. The operation of reducing chips in the area is not allowed.

However, the casino environment is intricate, and players or dealers often perform behaviors that affect the fairness of the game, and these behaviors will undoubtedly cause losses to the casino. Therefore, a system capable of monitoring the casino environment and alarming is very important to implement the method for point cloud data processing provided by the embodiments of the present disclosure, and thereby monitoring the behaviors of players and dealers during the game. Based on this, the embodiments of the present disclosure provide a monitoring and alarming system that can be applied to the casino environment. It should be understood that the monitoring and alarming system provided by the embodiments of the present disclosure can also be applied in other scenes, as long as the behaviors of objects in the scene needs to be analyzed.

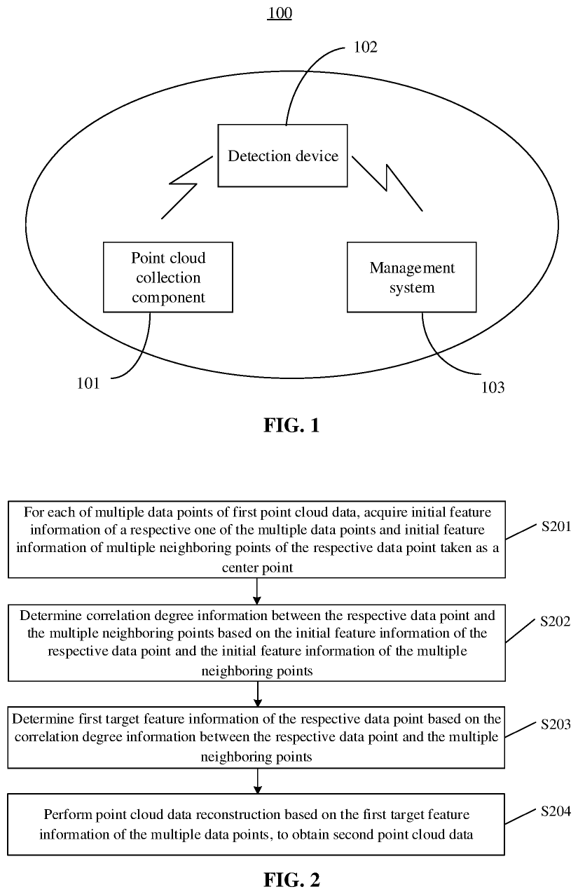

FIG. 1 is a structure diagram of a monitoring and alarming system according to an embodiment of the disclosure. As shown in FIG. 1, the system 100 may include a point cloud collection component 101, a detection device 102 and a management system 103.

The point cloud collection component 101 may include one or more laser point cloud scanners. The laser point cloud scanner may be a laser radar or a depth camera.

The point cloud collection component 101 may be in communication connection with the detection device 102. The detection device 102 may be connected with a server, so that the server may correspondingly control the detection device 102, and the detection device 102 may also use services provided by the server. In some implementations, the detection device 102 may correspond to only one point cloud collection component 101. In some other implementations, the detection device 102 may correspond to multiple point cloud collection components 101. In some implementations, the detection device 102 may be arranged in a game place. For example, the detection device 102 may be connected with a server in the game place. In some other implementations, the detection device 102 may be arranged in a cloud.

The detection device 102 may analyze a game table in the game place and a game player at the game table based on a real-time point cloud collected by the point cloud collection component, to determine whether an action of the game player conforms to a rule or is proper or not.

The detection device 102 may be in communication connection with the management system 103. When the detection device 102 determines that the game player takes an improper action, the detection device 102 may send target alarm information to the management system 103 on the game table corresponding to the game player that takes the improper action, such that the management system 103 may issue an alarm corresponding to the target alarm information to alarm the game player through the game table.

In some scenes, the detection device 102 may also be connected with a camera component arranged in the game place, to fuse the point cloud and image data for more refined analysis.

Compared with a two-dimensional picture or video, the data format of a point cloud may avoid loss of distance information between an object and a sensor, namely three-dimensional position information of the object in a space may be obtained. Ambiguities (for example, an ambiguity of a position of a human body in a three-dimensional space) brought by the two-dimensional picture or video may be avoided by a point cloud. Therefore, for determining whether the action of the dealer or the player conforms to the game rule or not more accurately, the point cloud collection component 101 may include a laser radar or a depth camera, and then three-dimensional point cloud data is acquired through the laser radar or the depth camera. However, how to generate point cloud features with rich details is a problem to be solved in this field.

In the related art, a calculation module, when extracting feature information of each data point in point cloud data, usually extracts the feature information of each data point by use of a fixed weight value. In this case, the calculation module may merely consider feature information of each data point per se, which greatly limits the flexibility, robustness and extensibility of the calculation module. In view of this, embodiments of the disclosure provide an efficient PSA calculation module. Correlations between neighboring points in a point cloud are adaptively learned to extract rich key point cloud features.

FIG. 2 is an implementation flowchart of a method for point cloud data processing according to an embodiment of the disclosure. As shown in FIG. 2, the method is applied to an apparatus for point cloud data processing. The method includes the following operations.

In S201, for each of multiple data points of first point cloud data, initial feature information of a respective data point of the multiple data points of first point cloud data and initial feature information of each of multiple neighboring points of the respective data point taken as a center point are acquired.

The apparatus for point cloud data processing may be a calculation module. The calculation module may be an enhanced point cloud feature extraction module. The calculation module may be deployed in a chip or a processor, etc. The chip or the processor may be applied to at least one of the following devices: a mobile phone, a pad, a computer with a wireless transceiver function, a palm computer, a desktop computer, a personal digital assistant, a portable media player, an intelligent speaker, a navigation device, a wearable device such as a smart watch, smart glasses and a smart necklace, a pedometer, a digital Television (TV), a Virtual Reality (VR) terminal device, an Augmented Reality (AR) terminal device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home and a vehicle, vehicle-mounted device or vehicle-mounted module in an Internet of vehicles system, etc.

In some implementations, the first point cloud data may be data collected through a laser radar or a depth camera. In the implementations, the first point cloud data may be incomplete point cloud data. In some other implementations, the first point cloud data may be data obtained by transforming the data collected through the laser radar or the depth camera. For example, the first point cloud data may be determined based on the incomplete point cloud data and rough complete point cloud data obtained by complementing the incomplete point cloud data. In the implementations, the first point cloud data may include the incomplete point cloud data and the rough complete point cloud data.

The point cloud data may include a large number of data points, and each data point has initial feature information. The apparatus for point cloud data processing may acquire the initial feature information of each data point and the initial feature information of each of the multiple neighboring points of the respective data point taken as the center point from the first point cloud data. Here, the initial feature information may include feature information representing position and/or information representing a relationship of relative position or attribute with other point(s) (for example, the points are all at a surface of a same object).

In an implementation process, the apparatus for point cloud data processing may acquire at least one batch of first point cloud data at one time, each batch of first point cloud data may include multiple data points, and each data point has initial feature information (i.e., multidimensional feature information). A batch of first point cloud data may be point cloud data in a three-dimensional image.

Each data point may correspond to the same number of corresponding neighboring points. The number of the neighboring points corresponding to each data point may be at least two. For example, the number of the neighboring points corresponding to each data point may be 2, 3, 5, 10, etc.

In S202, correlation degree information between the respective data point and the multiple neighboring points is determined based on the initial feature information of the respective data point and the initial feature information of each of the multiple neighboring points.

It is to be noted that the corresponding multiple neighboring points in the embodiment of the disclosure may refer to the multiple neighboring points corresponding to the respective data point, unless otherwise stated.

In the implementation process, if each data point corresponds to K neighboring points, the correlation degree information may include K pieces of correlation degree information, and each piece of correlation degree information in the K pieces of correlation degree information may represent a correlation degree between the respective data point and a respective one of the K neighboring points. Each piece of correlation degree information may be represented by a feature vector. A dimension of each piece of correlation degree information may be the same as or different from a dimension of the initial feature information of each data point.

In S203, first target feature information of the respective data point is determined based on the correlation degree information between the respective data point and the multiple neighboring points.

In some implementations, the apparatus for point cloud data processing may determine the first target feature information of each data point based on the initial feature information of each neighboring point in the corresponding multiple neighboring points (corresponding to the each data point) and the correlation degree information. In some other implementations, the apparatus for point cloud data processing may determine the first target feature information of each data point based on the initial feature information of each data point and the correlation degree information. In some implementations, the apparatus for point cloud data processing may determine the first target feature information of each data point based on the initial feature information of each data point, the initial feature information of each neighboring point in the corresponding multiple neighboring points and the correlation degree information.

In S204, point cloud data reconstruction is performed based on the first target feature information of each of the multiple data points to obtain second point cloud data.

In the implementation process, by use of any point cloud reconstruction method in the related art, the first point cloud data may be reconstructed based on the first target feature information of each data point in the multiple data points to obtain the second point cloud data. The first point cloud data may be obtained by merging a feature(s) of the incomplete point cloud data and a feature(s) of the rough incomplete point cloud data, and the second point cloud data may be data obtained by further complementing the first point cloud data refinedly. For example, in some implementations, the apparatus for point cloud data processing may execute at least one of the following operations on the obtained first target feature information of each data point: at least one dimension extension, at least one dimension compression, at least one Edge-preserved Pooling (EP) and at least one Edge-preserved Unpooling (EU), to obtain the second point cloud data. For example, the apparatus for point cloud data processing may process the obtained first target feature information of each data point for many times by alternately using an EP module and a Residual Point Selective Kernel module (R-PSK), obtain a first result through a fully connected layer, then process the first result for many times by alternately using an EU module and a shared Multilayer Perceptron (MLP), and obtain the second point cloud data by processing of MLPs. It is to be noted that another method may also be adopted to reconstruct the first point cloud data through the first target feature information of each data point, and any method for reconstructing the first point cloud data through the first target feature information of each data point shall fall within the scope of protection of the disclosure.

In the embodiment of the disclosure, the determined first target feature information of each data point is determined not only based on the initial feature information of the respective data point, but also based on the initial feature information of each of the multiple neighboring points corresponding to the respective data point, so that feature information of each data point is enriched. In addition, the first target feature information of each data point is determined based on the correlation degree information between the respective data point in the first point cloud data and the neighboring points, so that the obtained first target feature information of each data point may be as close as possible to a practical feature of the respective data point, and furthermore, the second point cloud data matched with the practical feature of the first point cloud data may be reconstructed based on the first target feature information of each data point.

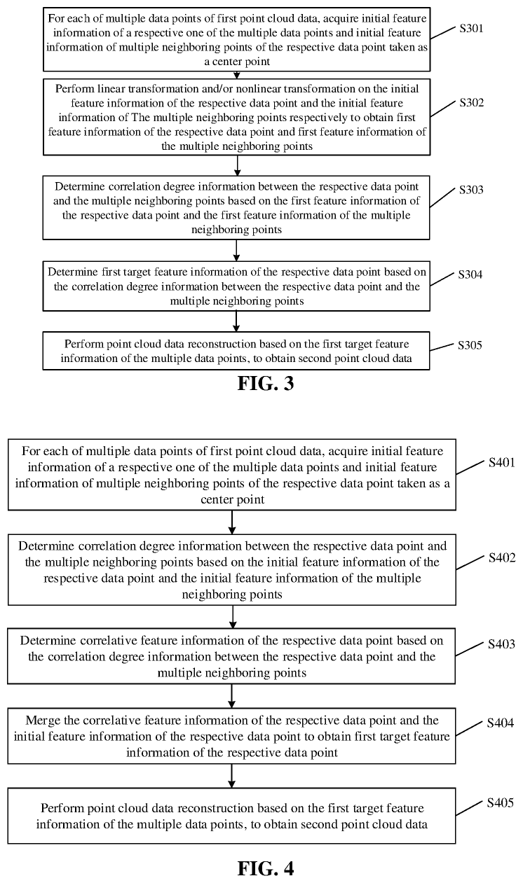

FIG. 3 is an implementation flowchart of another method for point cloud data processing according to an embodiment of the disclosure. As shown in FIG. 3, the method is applied to an apparatus for point cloud data processing. The method includes the following operations.

In S301, each data point in multiple data points of first point cloud data, initial feature information of a respective data point in multiple data points of first point cloud data and initial feature information of each of multiple neighboring points of the respective data point taken as a center point are acquired.

In S302, linear transformation and/or nonlinear transformation are/is performed on the initial feature information of the respective data point and the initial feature information of each of the multiple neighboring points respectively to obtain first feature information of the respective data point and first feature information of each of the multiple neighboring points.

In the embodiment of the disclosure, performing linear transformation and/or nonlinear transformation on any piece of feature information (for example, including the initial feature information, the first target feature information or starting feature information) may refer to performing linear transformation on the feature information, or performing nonlinear transformation on the feature information, or performing linear transformation and then nonlinear transformation on the feature information or performing nonlinear transformation and then linear transformation on the feature information, etc.

In some implementations, S302 may be implemented in the following manner: the initial feature information of each data point is input to a first perceptron to obtain the first feature information of the respective data point; and the initial feature information of each neighboring point is input to a second perceptron to obtain the first feature information of the respective neighboring point. In the embodiment of the disclosure, a dimension of the first feature information of each data point is the same as a dimension of the first feature information of each neighboring point of the respective data point.

In some other implementations, S302 may be implemented in the following manner dimension compression is performed on the initial feature information of each data point to obtain the first feature information of the respective data point; and dimension compression is performed on the initial feature information of each neighboring point to obtain the first feature information of the respective neighboring point.

In some other implementations, S302 may be implemented in the following manner dimension extension is performed on the initial feature information of each data point to obtain second feature information of the respective data point; dimension compression is performed on the second feature information of the respective data point to obtain the first feature information of the respective data point, the dimension of the first feature information of the respective data point being larger than a dimension of the initial feature information of the respective data point; dimension extension is performed on the initial feature information of each neighboring point to obtain second feature information of the respective neighboring point; and dimension compression is performed on the second feature information of the respective neighboring point to obtain the first feature information of the respective neighboring point, the dimension of the first feature information of the respective neighboring point being larger than a dimension of the initial feature information of the respective neighboring point.

In some implementations, the operation that dimension extension is performed on the initial feature information of each data point may include that: the initial feature information of the respective data point is input to the first perceptron, and dimension extension is performed on the initial feature information of the respective data point through a weight in the first perceptron. The operation that dimension extension processing is performed on the initial feature information of each neighboring point may include that: the initial feature information of the respective neighboring point is input to the second perceptron, and dimension extension processing is performed on the initial feature information of the respective neighboring point through a weight in the second perceptron.

In the embodiment of the disclosure, any perceptron (including the first perceptron, the second perceptron, a third perceptron, a fourth perceptron or a fifth perceptron, etc.) may be an Multilayer Perceptron (MLP). The MLP may be a shared MLP. The MLP is a feedforward artificial neural network and maps a group of input vectors to a group of output vectors. A dimension of the input vector may be larger than a dimension of the output vector.

Dimension compression over any piece of feature information may be one of linear transformations over the feature information. For example, in some feasible implementations, dimension compression may be performed on any piece of feature information through a matrix.

In some implementations, the dimension of the initial feature information may be C1, and under the actions of the first perceptron and the second perceptron, a dimension of the obtained second feature information may be C2. C2 may be larger than C1. In some implementations, the dimension of the first feature information obtained by performing dimension compression on the second feature information may be C2/r₁, where r₁ may be an integer greater than or equal to 2. For example, a value of r₁ may be 2, 3, 5, 8, etc.

Accordingly, dimension extension may be performed on the initial feature information of each data point and each neighboring point at first to extract feature information of more dimensions from the initial feature information of the respective data point and the respective neighboring point, and when the initial feature information of the respective data point and the respective neighboring point is extracted, parallel processing may be performed on data to achieve a great nonlinear global effect and realize powerful adaptation and self-learning functions. In addition, dimension compression is performed on the second feature information of each data point and each neighboring point, so that the dimensions of the second feature information of each data point and each neighboring point are reduced, and furthermore, a calculation burden of the apparatus for point cloud data processing in subsequent calculation through the first feature information of each data point and each neighboring point may be reduced.

In S303, correlation degree information between the respective data point and the multiple neighboring points is determined based on the first feature information of the respective data point and the first feature information of each of the multiple neighboring points.

In some implementations, the apparatus for point cloud data processing may execute an interactive operation (for example, a connection operation and/or a point multiplication operation) on the first feature information of each data point and the first feature information of each neighboring point, thereby obtaining the correlation degree information. The correlation degree information may represent a correlation degree between each data point and each neighboring point.

The apparatus for point cloud data processing may determine P-dimensional correlation degree information between each data point and each neighboring point based on P-dimensional first feature information of the respective data point and P-dimensional first feature information of the respective neighboring point, thereby obtaining the correlation degree information between the respective data point and the corresponding multiple neighboring points. It is to be noted that any implementation of determining a correlation degree between two vectors through the two vectors shall fall within the scope of protection of the disclosure.

In S304, first target feature information of the respective data point is determined based on the correlation degree information between the respective data point and the multiple neighboring points.

In S305, point cloud data reconstruction is performed based on the first target feature information of each of the multiple data points to obtain second point cloud data.

In the embodiment of the disclosure, linear transformation and/or nonlinear transformation may be performed on the initial feature information of each data point and the initial feature information of each of the multiple neighboring point corresponding to the respective data point to acquire the first feature information of the respective data point and the first feature information of each of the multiple neighboring points, the first feature information may be feature information extracted from the initial feature information and corresponding to a weight adopted for linear transformation and/or nonlinear transformation, and furthermore, the determined correlation degree information may represent correlation degrees between each data point and the corresponding multiple neighboring points for different types of features, so that the determined first target feature information of each data point may be consistent with a practical feature of the respective data point.

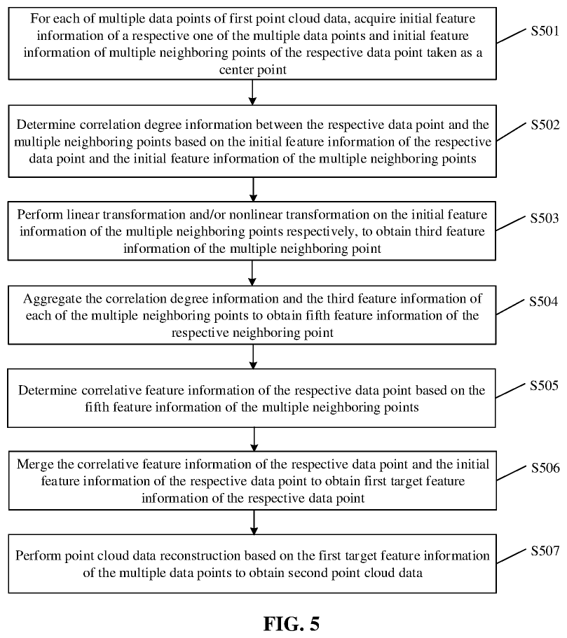

FIG. 4 is an implementation flowchart of another method for point cloud data processing according to an embodiment of the disclosure. As shown in FIG. 4, the method is applied to an apparatus for point cloud data processing. The method includes the following operations.

In S401, for each of multiple data points of first point cloud data, initial feature information of a respective one of the multiple data points and initial feature information of each of multiple neighboring points of the respective data point taken as a center point are acquired.

In S402, correlation degree information between the respective data point and the multiple neighboring points is determined based on the initial feature information of the respective data point and the initial feature information of each of the multiple neighboring points.

In S403, correlative feature information of the respective data point is determined based on the correlation degree information between the respective data point and the multiple neighboring points.

In some embodiments, the correlative feature information of the respective data point may be feature information calculated based on the initial feature information of the respective data point and the initial feature information of each of the multiple neighboring points. S403 may be implemented in the following manner: the initial feature information of each of the multiple neighboring points is determined as third feature information of the respective neighboring point; and the correlative feature information of each data point is determined based on the correlation degree information between the respective data point and the corresponding multiple neighboring points and the third feature information of each of the multiple neighboring points.

In some other embodiments, S403 may be implemented in the following manner linear transformation and/or nonlinear transformation are/is performed on the initial feature information of each of the multiple neighboring points respectively to obtain the third feature information of each of the multiple neighboring points; and the correlative feature information of each data point is determined based on the correlation degree information between the respective data point and the multiple neighboring points and the third feature information of each of the multiple neighboring points.

Accordingly, since the correlation degree information represents correlation degrees between each data point and the corresponding multiple neighboring points, the correlative feature information of each data point may be determined based on the correlation degree information, and the third feature information of each of the multiple neighboring points, extracted from the initial feature information of the respective neighboring point, to ensure that the determined correlative feature information of each data point may correspond to a real condition of the respective data point in the first point cloud data.

In some implementations, the operation that for each of the multiple neighboring points, linear transformation and/or nonlinear transformation are/is performed on the initial feature information of a respective one of the multiple neighboring points to obtain the third feature information of the respective neighboring point may include that: dimension extension is performed on the initial feature information of the respective neighboring point to obtain fourth feature information of the respective neighboring point; and dimension compression is performed on the fourth feature information of the respective neighboring point to obtain the third feature information of the respective neighboring point, a dimension of the third feature information of the respective neighboring point being larger than a dimension of the initial feature information of the respective neighboring point. In an implementation process, the operation that dimension extension is performed on the initial feature information of the respective neighboring point may include that: the initial feature information of the respective neighboring point is input to a third perceptron, and dimension extension processing is performed on the initial feature information of the respective neighboring point through a weight in the third perceptron.

A dimension of the fourth feature information of each neighboring point may be C2, and dimension compression processing may be performed on the fourth feature information of the respective neighboring point, thereby obtaining the C2/r2-dimensional third feature information of the respective neighboring point. In the embodiment of the disclosure, both r1 and r2 are integers greater than or equal to 2, r1 and r2 are different, and r1 and r2 are in a multiple relationship.

Dimensions of vectors output by the first perceptron, the second perceptron and the third perceptron may be the same. The weights in the first perceptron, the second perceptron and the third perceptron may be the same, or, the weights of at least two of them are different.

Accordingly, dimension extension may be performed on the initial feature information of each neighboring point to extract feature information of more dimensions from the initial feature information of the respective neighboring point, and when the fourth feature information of the respective neighboring point is extracted, parallel processing may be performed on data to achieve a great nonlinear global effect and realize powerful adaptation and self-learning functions, etc. In addition, dimension compression is performed on the fourth feature information of each neighboring point, so that the dimension of the fourth feature information of each neighboring point is reduced, and furthermore, a calculation burden of the apparatus for point cloud data processing in subsequent calculation through the third feature information of each neighboring point may be reduced.

In some other implementations, the operation that for each of the multiple neighboring points, linear transformation and/or nonlinear transformation are/is performed on the initial feature information of a respective one of the multiple neighboring points to obtain the third feature information of the respective neighboring point may include that: the initial feature information of the respective neighboring point is input to the third perceptron to obtain the third feature information of the respective neighboring point. In some other implementations, the operation that each of the multiple neighboring points, linear transformation and/or nonlinear transformation are/is performed on the initial feature information of a respective one of the multiple neighboring points to obtain the third feature information of the respective neighboring point may include that: dimension compression processing is performed on the initial feature information of the respective neighboring point to obtain the third feature information of the respective neighboring point.

In S404, the correlative feature information of the respective data point and the initial feature information of the respective data point are merged to obtain first target feature information of the respective data point.

The correlative feature information of the respective data point and the initial feature information of the respective data point may be merged in a residual transition connection manner.

In some implementations, merging the correlative feature information of each data point and the initial feature information of the respective data point may refer to performing tensor element-wise summation or tensor concatenation on the correlative feature information of the respective data point and the initial feature information of the respective data point. In an implementation process, under the condition that a dimension of the correlative feature information of each data point is larger than the dimension of the initial feature information of the respective data point, extension may be performed on the dimension of the initial feature information of the respective data point to obtain the dimension of the correlative feature information of the respective data point, and then summation is performed. Here, dimension extension includes, but is not limited to, duplication, linear transformation and/or nonlinear transformation.

In S405, point cloud data reconstruction is performed based on the first target feature information of each of the multiple data points to obtain second point cloud data.

In the embodiment of the disclosure, the correlative feature information of each data point is feature information extracted from the initial feature information of the respective data point and the initial feature information of the corresponding multiple neighboring points and obtained by complex calculation, so that a vanishing gradient problem is likely to occur to the determined correlative feature information of each data point. The correlative feature information of each data point and the initial feature information of the respective data point may be merged, so that the vanishing gradient problem would not occur for the determined first target feature information of each data point, and the initial feature information of each data point is preserved, which further improves the effectiveness of the determined first target feature information of each data point.

FIG. 5 is an implementation flowchart of another method for point cloud data processing according to an embodiment of the disclosure. As shown in FIG. 5, the method is applied to an apparatus for point cloud data processing. The method includes the following operations.

In S501, for each of multiple data points of first point cloud data, initial feature information of a respective one of the multiple data points and initial feature information of each of multiple neighboring points of the respective data point taken as a center point are acquired.

In S502, correlation degree information between the respective data point and the multiple neighboring points corresponding to the respective data point is determined based on the initial feature information of the respective data point and the initial feature information of each of the multiple neighboring points.

In S503, linear transformation and/or nonlinear transformation are/is performed on the initial feature information of each of the multiple neighboring points respectively to obtain third feature information of each neighboring point.

In S504, for each of the multiple neighboring points, the correlation degree information and the third feature information of a respective one of the multiple neighboring points are aggregated to obtain fifth feature information of the respective neighboring point.

In some implementations, under the condition that a dimension of the third feature information of each neighboring point is N times a dimension of the correlation degree information, the fifth feature information of each neighboring point is determined based on the third feature information of the respective neighboring point and N pieces of correlation degree information. N is an integer more than or equal to 1.

For example, under the condition that the dimension of the third feature information of each neighboring point is C2/r2, the dimension of the correlation degree information between the respective data point and the respective neighboring point is C2/r1 and C2/r2 is N times C2/r1, the C2/r2-dimensional correlation degree information may be duplicated for N times to obtain C2/r2-dimensional correlation degree information. Then, for each neighboring point, each element in the C2/r2-dimensional third feature information and a corresponding element in the C2/r2-dimensional correlation degree information are multiplied to obtain the C2/r2-dimensional fifth feature information of the respective neighboring point.

In some other implementations, under the condition that the dimension of the correlation degree information is M times the dimension of the third feature information of each neighboring point, the fifth feature information of the respective neighboring point is determined based on the correlation degree information and M pieces of third feature information of the respective neighboring point. M is an integer more than or equal to 1.

For example, under the condition that the dimension of the third feature information of each neighboring point is C2/r2, the dimension of the correlation degree information between the respective data point and the respective neighboring point is C2/r1 and C2/r1 is M times C2/r2, the C2/r2-dimensional third feature information of the respective neighboring point may be duplicated for M times to obtain C2/r1-dimensional third feature information of the respective neighboring point. Then, each element in the C2/r1-dimensional third feature information of the respective neighboring point and a corresponding element in the C2/r1-dimensional correlation degree information are multiplied to obtain the C2/r1-dimensional fifth feature information.

In S505, correlative feature information of the respective data point is determined based on the fifth feature information of each of the multiple neighboring points.

In some embodiments, S505 may be implemented in the following manner: dimension extension is performed on the fifth feature information of each of the multiple neighboring points respectively to obtain sixth feature information of each of the multiple neighboring points; and the correlative feature information of the respective data point is determined based on the sixth feature information of each of the multiple neighboring points.

Dimension extension over the fifth feature information of each neighboring point may be one of linear transformations over the fifth feature information of the respective neighboring point. For example, dimension extension may be performed on the fifth feature information of each neighboring point by use of a certain matrix or a certain perceptron. After dimension extension is performed on the fifth feature information of each neighboring point, the C2-dimensional sixth feature information of the respective neighboring point may be obtained.

Accordingly, since dimension compression is performed on features extracted through a perceptron to reduce a calculation burden of the apparatus for point cloud data processing, while dimension compression may result in feature loss, dimension extension may be performed on the fifth feature information of each neighboring point to recover features lost in dimension compression processing, to ensure that the sixth feature information includes more features. Therefore, more features of each data point may be mined to ensure that obtained feature information of the respective data point is richer.

In some embodiments, the operation that the correlative feature information of each data point is determined based on the sixth feature information of each of the multiple neighboring points may include that: feature values at the same dimension in the sixth feature information of each of the multiple neighboring points are added to obtain the correlative feature information of the respective data point.

In some other embodiments, the operation that the correlative feature information of each data point is determined based on the sixth feature information of each of the multiple neighboring points may include that: the feature values of the same dimension in the sixth feature information of each of the multiple neighboring points are added to obtain third feature information of the respective data point; and linear transformation and/or nonlinear transformation are/is performed on the third feature information of the respective data point to obtain the correlative feature information of the respective data point.

Accordingly, the feature values of the same dimension in the sixth feature information of each of the multiple neighboring points may be added to obtain the correlative feature information of the respective data point, so that a solution for determining feature information of a data point according to feature information of each of multiple neighboring points is provided. In addition, since the correlative feature information of each data point is determined based on the feature information of each of the multiple neighboring points, the obtained correlative feature information of each data point may be determined based on the feature information of each of the multiple neighboring points, and furthermore, the determined correlative feature information of each data point may be as close as possible to a practical feature of the respective data point.

In S506, the correlative feature information of the respective data point and the initial feature information of the respective data point are merged to obtain first target feature information of the respective data point.

In S507, point cloud data reconstruction is performed based on the first target feature information of each of the multiple data points to obtain second point cloud data. In the embodiment of the disclosure, the third feature information of each neighboring point and the correlation degree information are aggregated, so that extracted features may be enhanced, and furthermore, the determined correlative feature information of each data point may be as close as possible to the practical feature of the respective data point.

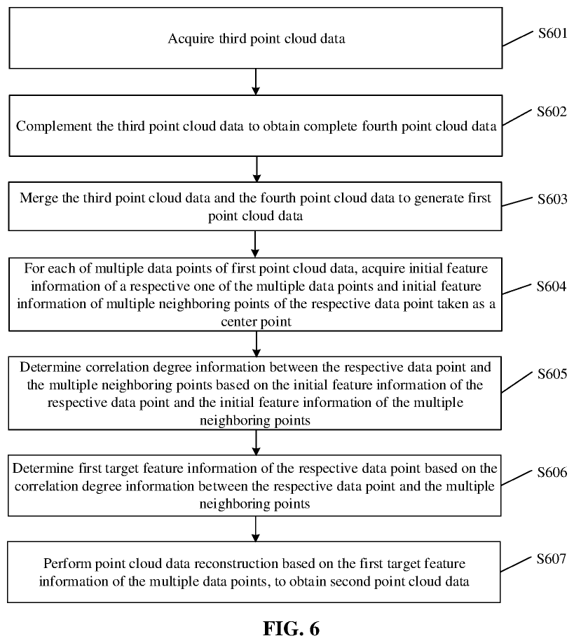

FIG. 6 is an implementation flowchart of a method for point cloud data processing according to another embodiment of the disclosure. As shown in FIG. 6, the method is applied to an apparatus for point cloud data processing. The method includes the following operations.

In S601, third point cloud data is acquired.

The third point cloud data may be point cloud data collected through a depth camera or a laser radar.

In S602, the third point cloud data is complemented to obtain corresponding complete fourth point cloud data.

In another embodiment, the fourth point cloud data may be called rough point cloud data or rough complete point cloud data.

Determination of the fourth point cloud data corresponding to the third point cloud data may be implemented in multiple manners, and this is not the main concern of the embodiment of the disclosure and thus will not be elaborated in the embodiment of the disclosure.

In S603, the third point cloud data and the fourth point cloud data are merged to generate first point cloud data.

In some implementations, S603 may be implemented in the following manner the third point cloud data and the fourth point cloud data are merged to obtain input point cloud data; starting feature information of each of the multiple data points of the input point cloud data is acquired; and linear transformation and/or nonlinear transformation are/is performed on the starting feature information of each of the multiple data points respectively to obtain the first point cloud data.

In an implementation process, the apparatus for point cloud data processing may input the starting feature information of each of the multiple data points to a fifth perceptron and process the starting feature information of each of the multiple data points respectively through a weight of the fifth perceptron to obtain the first point cloud data.

Merging the third point cloud data and the fourth point cloud data may refer to performing tensor concatenation on the third point cloud data and the fourth point cloud data. In some other embodiments, merging the third point cloud data and the fourth point cloud data may refer to performing tensor element-wise summation on the third point cloud data and the fourth point cloud data.

Accordingly, linear transformation and/or nonlinear transformation are/is performed on the starting feature information of each data point of the input point cloud data to obtain the first point cloud data, so that initial feature information of each data point in the first point cloud data is feature information extracted from the starting feature information of the respective data point and corresponding to a weight adopted for linear transformation and/or nonlinear transformation, and furthermore, feature information of each data point in the first point cloud data may be enriched.

In some other implementations, S603 may be implemented in the following manner the third point cloud data and the fourth point cloud data are merged to obtain the input point cloud data, and the point cloud data is determined as the first point cloud data.

In S604, for each of multiple data points of first point cloud data, initial feature information of a respective one of the multiple data points of first point cloud data and initial feature information of each of multiple neighboring points of the respective data point taken as a center point are acquired.

In S605, correlation degree information between the respective data point and the multiple neighboring points corresponding to the respective data point is determined based on the initial feature information of the respective data point and the initial feature information of each of the multiple neighboring points.

In S606, first target feature information of the respective data point is determined based on the correlation degree information between the respective data point and the multiple neighboring points.

In S607, point cloud data reconstruction is performed based on the first target feature information of each of the multiple data points to obtain second point cloud data.

In some embodiments, S606 may be implemented in the following manner the first target feature information of each data point is determined as second target feature information of the respective data point; the second target feature information of each data point and the starting feature information of the respective data point are merged to obtain third feature information of respective data point; and point cloud data reconstruction is performed based on the third feature information of each of the multiple data points to obtain the second point cloud data.

In some other embodiments, S606 may be implemented in the following manner linear transformation and/or nonlinear transformation are/is performed on target feature information of each data point to obtain the second target feature information of the respective data point; the second target feature information of each data point and the starting feature information of the respective data point are merged to obtain the third feature information of the respective data point; and point cloud data reconstruction is performed based on the third feature information of each of the multiple data points to obtain the second point cloud data.

The operation that linear transformation and/or nonlinear transformation are/is performed on the target feature information of each data point may be implemented in the following manner the target feature information of each data point is input to a sixth perceptron to obtain the second target feature information of the respective data point.

The third target feature information of each data point is configured to determine fine complete point cloud data corresponding to the third point cloud data. The accuracy of the fine complete point cloud data is higher than the accuracy of the fourth point cloud data.

Accordingly, after the first target feature information of each data point is acquired, the second target feature information of the respective data point may be determined. Since the second target feature information of each data point is feature information obtained by complex calculation, the second target feature information of the respective data point and the starting feature information of the respective data point may be merged to solve a vanishing gradient problem of obtained output point cloud data and ensure that the starting feature information of the respective data point is preserved in the third target feature information of the respective data point.

In the embodiment of the disclosure, since the first point cloud data is determined based on the third point cloud data and the fourth point cloud data obtained by complementing the third point cloud data, a combination of the third point cloud data and the fourth point cloud data is utilized for determining the first target feature information of each data point of the first point cloud data. Therefore, not only feature information of each data point in the third point cloud data but also feature information of the respective data point in the fourth point cloud data is preserved in the obtained first target feature information of the respective data point, and furthermore, the feature information of each data point is enriched to ensure that the obtained first target feature information of the respective data point includes more features.

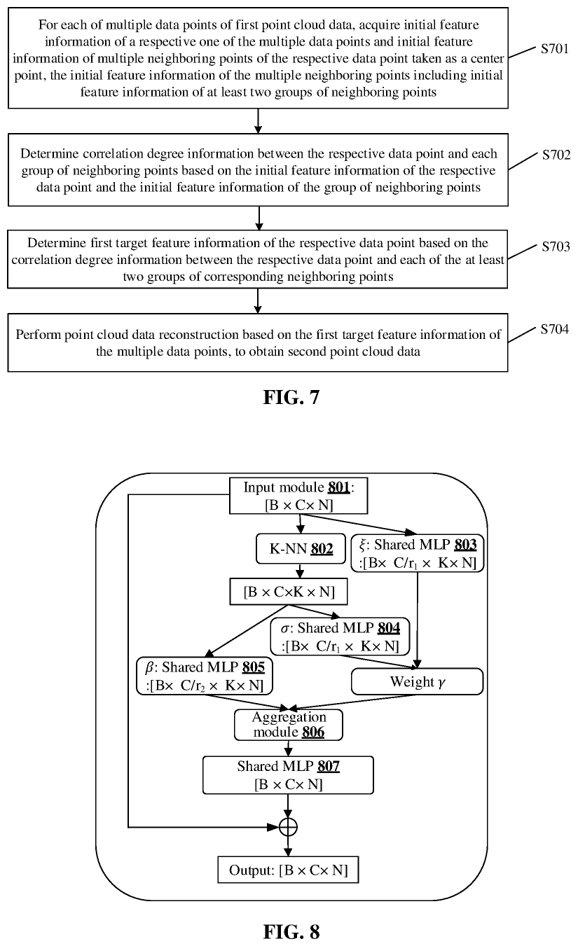

FIG. 7 is an implementation flowchart of a method for point cloud data processing according to another embodiment of the disclosure. As shown in FIG. 7, the method is applied to an apparatus for point cloud data processing. The method includes the following operations.

In S701, for each of multiple data points of first point cloud data, initial feature information of a respective one of the multiple data points and initial feature information of each of multiple neighboring points of the respective data point taken as a center point are acquired, the initial feature information of each of the multiple neighboring points including initial feature information of at least two groups of neighboring points.

Each group of neighboring points include multiple neighboring points. The numbers of the neighboring points in any two groups of neighboring points in the at least two groups of neighboring points are different.

In S702, for each group of neighboring points, correlation degree information between the respective data point and the group of neighboring points is determined based on the initial feature information of the respective data point and the initial feature information of the group of neighboring points.

In S703, first target feature information of the respective data point is determined based on the correlation degree information between the respective data point and the at least two groups of neighboring points.

In S704, point cloud data reconstruction is performed based on the first target feature information of each of the multiple data points to obtain second point cloud data.

In some implementations, under the condition that the at least two groups of neighboring points include a first group of neighboring points and a second group of neighboring points, the first group of neighboring points include K1 neighboring points, the second group of neighboring points include K2 neighboring points, K2 being different from K1, and first correlation degree information and second correlation degree information may be obtained respectively, so that the apparatus for point cloud data processing may determine a first group of feature information of each data point based on the first correlation degree information and determine a second group of feature information of each data point based on the second correlation degree information. Then, the first target feature information is determined based on the first group of feature information and the second group of feature information. A manner for determining the first group of feature information and second group of feature information of each data point based on the first correlation degree information and the second correlation degree information respectively may refer to the descriptions in the abovementioned embodiments.

In the embodiment of the disclosure, the correlation degree information between each data point and each group of corresponding neighboring points is determined based on the initial feature information of the respective data point and the initial feature information of the respective group of neighboring points in the at least two groups of neighboring points, and the first target feature information of the respective data point is determined based on the at least two pieces of correlation degree information, so that the obtained first target feature information of the respective data point is determined according to feature information of different numbers of neighboring points in multiple groups, and the richness of the determined first target feature information of the respective data point is improved.

In the embodiment of the disclosure, a structural relation such as symmetry in a point cloud may be learned through a self-attention kernel, so that more effective information is acquired, and the performance of a point cloud related task is improved.

An architecture of a PSA kernel will be described below.

FIG. 8 is a schematic diagram of an architecture of a PSA kernel according to an embodiment of the disclosure. The PSA kernel may be the abovementioned apparatus for point cloud data processing or included in the abovementioned apparatus for point cloud data processing, as shown in FIG. 8.

First, point cloud data [B×C×N] is input to an input module 801. B represents a batch size, and the batch size may indicate the number of batches of first point cloud data input to the apparatus for point cloud data processing at one time. C represents a feature size, and the feature size may indicate a dimension of a feature. N represents a point number, and the point number may indicate the number of points in the first point cloud data.

Then, K neighboring points [B×C×K×N] of [B×C×N] are determined based on a K-Nearest Neighbor (KNN) algorithm 802. [B×C×N] corresponds to the initial feature information of each data point in the abovementioned embodiments. [B×C×K×N] corresponds to the initial feature information of the corresponding multiple neighboring points in the abovementioned embodiments.

Next, dimension increasing transformation is performed on the point cloud [B×C×N] through a shared MLP 803, and then dimension reduction is performed by use of a parameter r₁ to convert it to [B×C/r₁×1×N]. Dimension increasing transformation is performed on [B×C×K×N] through a shared MLP 804, and then dimension reduction is performed by use of the parameter r₁ to convert it to [B×C/r₁×K×N]. A weight γ configured to represent a relation between each data point and corresponding multiple neighboring points is determined based on [B×C/r₁×1×N] and [B×C/r₁×K×N]. The weight γ corresponds to the abovementioned correlation degree information between each data point and the corresponding multiple neighboring points.

Later on, dimension increasing transformation is performed on [B×C×K×N] through a shared MLP 805, and then dimension reduction is performed by use of a parameter r₂ to convert it to [B×C/r₂×K×N]. [B×C/r₂×K×N] and the weight γ are input to an aggregation module 806 for aggregation. The operation that [B×C/r₂×K×N] and the weight γ are input to the aggregation module 806 for aggregation corresponds to the abovementioned operation that the correlative feature information of each data point is determined based on the correlation degree information between the respective data point and the corresponding multiple neighboring points and the third feature information of each of the multiple neighboring points.

Finally, an aggregation result is input to a shared MLP 807 to obtain [B×C×N], and then [B×C×N] of the input module and [B×C×N] obtained based on the shared MLP 807 are merged by residual transition connection to output [B×C×N]. In such a manner, correlations between the neighboring points in the point cloud are adaptively learned to extract rich key point cloud features. Through the feature information, the performance of a point cloud completion network may be enhanced.

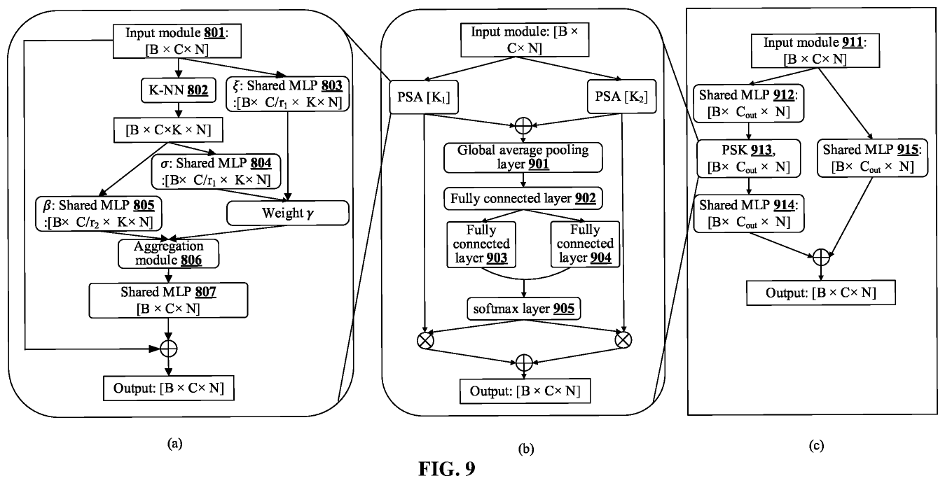

FIG. 9 is a schematic diagram of an architecture of a target point kernel according to an embodiment of the disclosure. As shown in FIG. 9, the PSA kernel in FIG. 8 is included in the architecture of the target point kernel in FIG. 9.

The target point kernel may include the PSA kernel (part (a) in FIG. 9), a Point Selective Kernel (PSK) module (part (b) in FIG. 9) and an R-PSK module (part (c) in FIG. 9).

A two-branch case is shown in part (b) in FIG. 9, namely two PSA modules PSA[K1] and PSA[K2] are included. The two PSA kernels have different kernel (i.e., K−NN) sizes. First, the two kernel modules PSA[K1] and PSA[K2] are fused, and a fusion result is input to a global average pooling layer 901. Then, an output result of the global average pooling layer 901 is input to a fully connected layer 902. Next, an output result of the fully connected layer 902 is input to fully connected layers 903 and 904 respectively. Later on, output results of the fully connected layers 903 and 904 are input to a softmax layer 905. Then, a processing result, output by the softmax layer 905, for the output result of the fully connected layer 903 is fused with a result of the PSA[K1], and a processing result, output by the softmax layer 905, for the output result of the fully connected layer 904 is fused with a result of the PSA[K2]. Finally, two fusion results are fused again to obtain a final output result, i.e., an output fine complete point cloud model.

In part (c) in FIG. 9, first, point cloud data is input to an input module 911 in a manner of [B×Cin×N]. Then, the input [B×Cin×N] is processed through a shared MLP 912, and [B×Cout×N] is output. Next, the output [B×Cout×N] is input to PSK 913 to obtain [B×Cout×N] output by PSK 913. Finally, the [B×Cout×N] output by PSK 913 is processed through a shared MLP 914, and a processing result is fused with [B×Cout×N] output by a shared MLP 915 to obtain a final output result.

In some other implementations, the target point kernel may include no PSK module. In such case, PSK 913 in part (c) in FIG. 9 is modified with PSA, namely the output of the shared MLP 912 is transmitted to an input of PSA and the input of PSA is transmitted to the MLP 914.

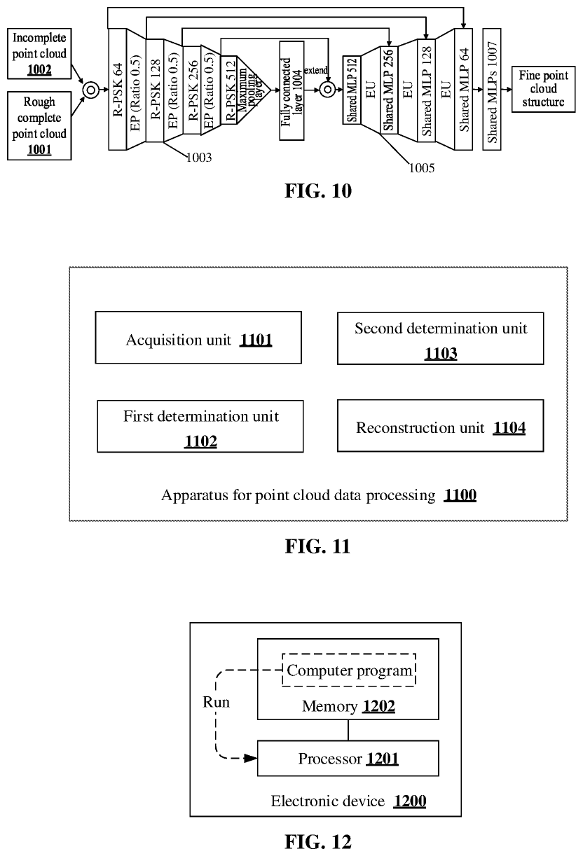

FIG. 10 is a structure diagram of a relation improvement network according to an embodiment of the disclosure. As shown in FIG. 10, a Residual Network (RENet) implements a hierarchical coder-decoder system structure through EP and EU modules. In FIG. 10, a rough complete point cloud 1001 and a third point cloud 1002 are taken as inputs of a hierarchical coder 1003. In the hierarchical coder 1003, a feature(s) of input point cloud data is/are coded sequentially through R-PSK64, R-PSK128, R-PSK256 and R-PSK512 to finally obtain point cloud feature data having a point cloud feature dimension of 512. An output result of the R-PSK is processed through multiple layers of EP to implement hierarchical coding. An output result of the coder is input to a fully connected layer 1004, and an output result of the fully connected layer 1004 is fused with the output result of the R-PSK512 to extend the feature dimension. A fusion result is decoded through a hierarchical decoder 1005, and is processed through multiple layers of EU at the hierarchical decoder 1005 to implement hierarchical decoding, thereby obtaining an output result of R-PSK64. Finally, the output result of the R-PSK64 is processed through a shared MLP 1007 to obtain a final fine point cloud structure.

In such a manner, point features may be extended by use of edge sensing feature extension modules to generate a high-resolution complete point cloud with predicted refined local details. Therefore, refined details may be generated by use of a multi-scale structural relation.

Based on the abovementioned embodiments, an embodiment of the disclosure provides an apparatus for point cloud data processing. Each unit of the apparatus and each module of each unit may be implemented through a processor in an electronic device.

FIG. 11 is a structure diagram of an apparatus for point cloud data processing according to an embodiment of the disclosure. As shown in FIG. 11, the apparatus for point cloud data processing 1100 includes an acquisition unit 1101, a first determination unit 1102, a second determination unit 1103 and a reconstruction unit 1104.

The acquisition unit 1101 is configured to, for each of multiple data points of first point cloud data, acquire initial feature information of a respective one of the multiple data points of the first point cloud data and initial feature information of each of multiple neighboring points of the respective data point taken as a center point.

The first determination unit 1102 is configured to determine correlation degree information between the respective data point and the corresponding multiple neighboring points based on the initial feature information of the respective data point and the initial feature information of the corresponding multiple neighboring points.

The second determination unit 1103 is configured to determine first target feature information of the respective data point based on the correlation degree information between the respective data point and the corresponding multiple neighboring points.

The reconstruction unit 1104 is configured to perform point cloud data reconstruction based on the first target feature information of each of the multiple data points to obtain second point cloud data.

In some embodiments, the first determination unit 1102 is further configured to perform linear transformation and/or nonlinear transformation on the initial feature information of the respective data point and the initial feature information of each of the multiple neighboring points respectively to obtain first feature information of the respective data point and first feature information of each of the multiple neighboring points and determine the correlation degree information between the respective data point and the multiple neighboring points based on the first feature information of the respective data point and the first feature information of each of the multiple neighboring points.

In some embodiments, the first determination unit 1102 is further configured to perform dimension extension on the initial feature information of the respective data point to obtain second feature information of the respective data point, perform dimension compression on the second feature information of the respective data point to obtain the first feature information of the respective data point, a dimension of the first feature information of the respective data point being larger than a dimension of the initial feature information of the respective data point, perform dimension extension on the initial feature information of each of the multiple neighboring points respectively to obtain second feature information of each of the multiple neighboring points and perform dimension compression on the second feature information of each of the multiple neighboring points respectively to obtain the first feature information of each of the multiple neighboring points, a dimension of the first feature information of each of the multiple neighboring points being larger than a dimension of the initial feature information of each of the multiple neighboring points.

In some embodiments, the second determination unit 1103 is further configured to determine correlative feature information of the respective data point based on the correlation degree information between the respective data point and the multiple neighboring points and merge the correlative feature information of the respective data point and the initial feature information of the respective data point to obtain the first target feature information of the respective data point.

In some embodiments, the second determination unit 1103 is further configured to perform linear transformation and/or nonlinear transformation on the initial feature information of each of the multiple neighboring points respectively to obtain third feature information of each of the multiple neighboring points and determine the correlative feature information of the respective data point based on the correlation degree information between the respective data point and the multiple neighboring points and the third feature information of each of the multiple neighboring points.

In some embodiments, the second determination unit 1103 is further configured to perform dimension extension on the initial feature information of each of the multiple neighboring points respectively, to obtain fourth feature information of each of the multiple neighboring points and perform dimension compression on the fourth feature information of each of the multiple neighboring points respectively, to obtain the third feature information of each of the multiple neighboring points, a dimension of the third feature information of each of the multiple neighboring points being larger than the dimension of the initial feature information of each of the multiple neighboring points.

In some embodiments, the second determination unit 1103 is further configured to aggregate the correlation degree information and the third feature information of each of the multiple neighboring points to obtain fifth feature information of a respective one of the multiple neighboring points and determine the correlative feature information of the respective data point based on the fifth feature information of each of the multiple neighboring points.

In some embodiments, the second determination unit 1103 is further configured to perform dimension extension on the fifth feature information of each of the multiple neighboring points respectively to obtain sixth feature information of each of the multiple neighboring points and determine the correlative feature information of the respective data point based on the sixth feature information of each of the multiple neighboring points.

In some embodiments, the acquisition unit 1101 is further configured to acquire third point cloud data, complement the third point cloud data to obtain complete fourth point cloud data and merge the third point cloud data and the fourth point cloud data to generate the first point cloud data.

In some embodiments, the acquisition unit 1101 is further configured to merge the third point cloud data and the fourth point cloud data to obtain input point cloud data, acquire starting feature information of each data point in multiple data points of the input point cloud data and perform linear transformation and/or nonlinear transformation on the starting feature information of a respective one of the data points, to obtain the first point cloud data.

In some embodiments, the reconstruction unit 1104 is further configured to determine the first target feature information of the respective data point as second target feature information of the respective data point, or, perform linear transformation and/or nonlinear transformation on the first target feature information of the respective data point to determine the second target feature information of the respective data point, merge the second target feature information of the respective data point and the starting feature information of the respective data point to obtain third target feature information of the respective data point and perform point cloud data reconstruction based on the third target feature information of each of the multiple data points to obtain the second point cloud data.

In some embodiments, the initial feature information of each of the multiple neighboring points includes initial feature information of at least two groups of neighboring points, each group of neighboring points include multiple neighboring points, and the numbers of the neighboring points in any two groups of neighboring points in the at least two groups of neighboring points are different. The first determination unit 1102 is further configured to, for each group of neighboring points corresponding to the respective data point, determine correlation degree information between the respective data point and the group of neighboring points based on the initial feature information of the respective data point and the initial feature information of the group of neighboring points. The second determination unit 1103 is further configured to determine the first target feature information of the respective data point based on the correlation degree information between the respective data point and each group of neighboring points in the at least two groups of neighboring points corresponding to the respective data point.

The apparatus for point cloud data processing 1100 is the apparatus for point cloud data processing in any abovementioned method.

The above descriptions about the apparatus embodiments are similar to descriptions about the method embodiments and beneficial effects similar to those of the method embodiments are achieved. Technical details undisclosed in the apparatus embodiments of the disclosure may be understood with reference to the descriptions about the method embodiments of the disclosure.

It is to be noted that, in the embodiments of the disclosure, when being implemented in form of a software function module and sold or used as an independent product, the method for point cloud data processing may also be stored in a computer storage medium. Based on such an understanding, the technical solutions of the embodiments of the disclosure substantially or parts making contributions to the related art may be embodied in form of a software product. The computer software product is stored in a storage medium, including a plurality of instructions configured to enable an electronic device to execute all or part of the method in each embodiment of the disclosure. The storage medium includes various media capable of storing program codes such as a U disk, a mobile hard disk, a Read Only Memory (ROM), a magnetic disk or an optical disk. As a consequence, the embodiments of the disclosure are not limited to any specific hardware and software combination.

FIG. 12 is a schematic diagram of a hardware entity of an electronic device according to an embodiment of the disclosure. As shown in FIG. 12, the hardware entity of the electronic device 1200 includes a processor 1201 and a memory 1202. The memory 1202 stores a computer program capable of running in the processor 1201. The processor 1201 executes the program to implement the steps in the method of any abovementioned embodiment. The electronic device 1200 may be any device applied to a chip or processor listed above.

The memory 1202 stores the computer program capable of running in the processor 1201. The memory 1202 is configured to store an instruction and application executable for the processor 1201, may also cache data (for example, image data, audio data, voice communication data and video communication data) to be processed or having been processed by the processor 1201 and each module in the electronic device 1200 and may be implemented through a flash or a Random Access Memory (RAM).

The processor 1201 executes the program to implement the steps of any abovementioned method for point cloud data processing. The processor 1201 usually controls overall operations of the electronic device 1200.

An embodiment of the disclosure provides a computer storage medium, which stores one or more programs. The one or more programs may be executed by one or more processors to implement the steps of the method for point cloud data processing in any abovementioned embodiment.

It is to be pointed out here that the above descriptions about the storage medium and device embodiments are similar to the descriptions about the method embodiment and beneficial effects similar to those of the method embodiment are achieved. Technical details undisclosed in the storage medium and device embodiments of the disclosure are understood with reference to the descriptions about the method embodiment of the disclosure.

The processor or apparatus for point cloud data processing in the embodiments of the disclosure may be an integrated circuit chip and has a signal processing capability. In an implementation process, each step of the method embodiments may be completed by an integrated logical circuit of hardware in the processor or an instruction in a software form. The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing unit (CPU), a Graphics Processing Unit (GPU), a Neural-network Processing Unit (NPU), a controller, a microcontroller and a microprocessor. The processor or the apparatus for point cloud data processing may implement or execute each method, step and logical block diagram disclosed in the embodiments of the disclosure. The universal processor may be a microprocessor or the processor may also be any conventional processor, etc. The steps of the method disclosed in combination with the embodiment of the disclosure may be directly embodied to be executed and completed by a hardware decoding processor or executed and completed by a combination of hardware and software modules in the decoding processor. The software module may be located in a mature storage medium in this field such as a RAM, a flash memory, a ROM, a Programmable ROM (PROM) or Electrically Erasable PROM (EEPROM) and a register. The storage medium is located in a memory, and the processor reads information in the memory and completes the steps of the method in combination with hardware.

It can be understood that the memory or computer storage medium in the embodiments of the disclosure may be a volatile memory or a nonvolatile memory, or may include both the volatile and nonvolatile memories. The nonvolatile memory may be a ROM, a PROM, an Erasable PROM (EPROM), an EEPROM or a flash memory. The volatile memory may be a RAM, and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DR RAM). It is to be noted that the memory of a system and method described in the disclosure is intended to include, but not limited to, memories of these and any other proper types.

It is to be understood that “one embodiment” or “an embodiment” or “the embodiment of the disclosure” or “the abovementioned embodiment” or “some implementations” or “some embodiments” mentioned in the whole specification means that specific features, structures or features related to the embodiment are included in at least one embodiment of the disclosure. Therefore, “in one embodiment” or “in an embodiment” or “the embodiment of the disclosure” or “the abovementioned embodiment” or “some implementations” or “some embodiments” appearing everywhere in the whole specification does not always refer to the same embodiment. In addition, these specific features, structures or features may be combined in one or more embodiments in any proper manner. It is to be understood that, in each embodiment of the disclosure, a magnitude of a sequence number of each process does not mean an execution sequence and the execution sequence of each process should be determined by its function and an internal logic and should not form any limit to an implementation process of the embodiments of the disclosure. The sequence numbers of the embodiments of the disclosure are adopted not to represent superiority-inferiority of the embodiments but only for description.

In some embodiments provided by the disclosure, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some features may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each functional unit in each embodiment of the disclosure may be integrated into a processing unit, each unit may also serve as an independent unit and two or more than two units may also be integrated into a unit. The integrated unit may be implemented in a hardware form and may also be implemented in form of hardware and software functional unit.

The methods disclosed in some method embodiments provided in the disclosure may be freely combined without conflicts to obtain new method embodiments.

The features disclosed in some product embodiments provided in the disclosure may be freely combined without conflicts to obtain new product embodiments.

The features disclosed in some method or device embodiments provided in the disclosure may be freely combined without conflicts to obtain new method embodiments or device embodiments.

Those of ordinary skill in the art should know that all or part of the steps of the method embodiment may be implemented by related hardware instructed through a program, the program may be stored in a computer storage medium, and the program is executed to execute the steps of the method embodiment. The storage medium includes: various media capable of storing program codes such as a mobile storage device, a ROM, a magnetic disk or a compact disc.

Or, when being implemented in form of a software function module and sold or used as an independent product, the integrated unit of the disclosure may also be stored in a computer storage medium. Based on such an understanding, the technical solutions of the embodiments of the disclosure substantially or parts making contributions to the related art may be embodied in form of a software product. The computer software product is stored in a storage medium, including a plurality of instructions configured to enable a computer device (which may be a personal computer, a server, a network device or the like) to execute all or part of the method in each embodiment of the disclosure. The storage medium includes: various media capable of storing program codes such as a mobile hard disk, a ROM, a magnetic disk or a compact disc.

In the embodiments of the disclosure, the descriptions about the same steps and the same contents in different embodiments may refer to those in the other embodiments. Singular forms “a/an”, “said” and “the” used in the embodiments and appended claims of the disclosure are also intended to include plural forms unless other meanings are clearly expressed in the context.

It is to be understood that term “and/or” used in the disclosure is only an association relationship describing associated objects and represents that three relationships may exist. For example, A and/or B may represent three conditions: independent existence of A, existence of both A and B and independent existence of B. In addition, character “/” in the disclosure usually represents that previous and next associated objects form an “or” relationship.

It is to be noted that, in each embodiment involved in the disclosure, all the steps may be executed or part of the steps may be executed if a complete technical solution may be formed.

The above is only the implementation of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for point cloud data processing, comprising:
for each of multiple data points of first point cloud data, acquiring initial feature information of a respective one of the multiple data points of first point cloud data and initial feature information of each of multiple neighboring points of the respective data point taken as a center point;
determining correlation degree information between the respective data point and the multiple neighboring points based on the initial feature information of the respective data point and the initial feature information of each of the multiple neighboring points;
determining first target feature information of the respective data point based on the correlation degree information between the respective data point and the multiple neighboring points; and
performing point cloud data reconstruction based on the first target feature information of each of the multiple data points, to obtain second point cloud data.

2. The method of claim 1, wherein determining the correlation degree information between the respective data point and the multiple neighboring points based on the initial feature information of the respective data point and the initial feature information of each of the multiple neighboring points comprises:
performing at least one of linear transformation or nonlinear transformation on the initial feature information of the respective data point and the initial feature information of each of the multiple neighboring points respectively to obtain first feature information of the respective data point and first feature information of each of the multiple neighboring points; and
determining the correlation degree information between the respective data point and the multiple neighboring points based on the first feature information of the respective data point and the first feature information of each of the multiple neighboring points.

3. The method of claim 2, wherein performing at least one of linear transformation or nonlinear transformation on the initial feature information of the respective data point and the initial feature information of each of the multiple neighboring points respectively to obtain the first feature information of the respective data point and the first feature information of each of the multiple neighboring points comprises:
performing dimension extension on the initial feature information of the respective data point to obtain second feature information of the respective data point;
performing dimension compression on the second feature information of the respective data point to obtain the first feature information of the respective data point, a dimension of the first feature information of the respective data point being larger than a dimension of the initial feature information of the respective data point;
performing dimension extension on the initial feature information of each of the multiple neighboring points to obtain second feature information of each of the multiple neighboring points; and
performing dimension compression on the second feature information of each of the multiple neighboring points to obtain the first feature information of each of the multiple neighboring points, a dimension of the first feature information of each of the multiple neighboring points being larger than a dimension of the initial feature information of each of the multiple neighboring points.

4. The method of claim 1, wherein determining the first target feature information of the respective data point based on the correlation degree information between the respective data point and each of the multiple neighboring points comprises:
determining correlative feature information of the respective data point based on the correlation degree information between the respective data point and the multiple neighboring points; and
merging the correlative feature information of the respective data point and the initial feature information of the respective data point, to obtain the first target feature information of the respective data point.

5. The method of claim 4, wherein determining the correlative feature information of the respective data point based on the correlation degree information between the respective data point and the multiple neighboring points comprises:
performing at least one of linear transformation or nonlinear transformation on the initial feature information of each of the multiple neighboring points respectively, to obtain third feature information of each of the multiple neighboring points; and
determining the correlative feature information of the respective data point based on the correlation degree information between the respective data point and the multiple neighboring points and the third feature information of each of the multiple neighboring points.

6. The method of claim 5, wherein performing at least one of linear transformation or nonlinear transformation on the initial feature information of each of the multiple neighboring points to obtain the third feature information of each of the multiple neighboring points comprises:
performing dimension extension on the initial feature information of each of the multiple neighboring points respectively, to obtain fourth feature information of each of the multiple neighboring points; and
performing dimension compression on the fourth feature information of each of the multiple neighboring points respectively, to obtain the third feature information of each of the multiple neighboring points, a dimension of the third feature information of each of the multiple neighboring points being larger than the dimension of the initial feature information of each of the multiple neighboring points.

7. The method of claim 5, wherein determining the correlative feature information of the respective data point based on the correlation degree information between the respective data point and each of the multiple neighboring points and the third feature information of each of the multiple neighboring points comprises:
aggregating the correlation degree information and the third feature information of each of the multiple neighboring points, to obtain fifth feature information of each of the multiple neighboring points; and
determining the correlative feature information of the respective data point based on the fifth feature information of each of the multiple neighboring points.

8. The method of claim 7, wherein determining the correlative feature information of the respective data point based on the fifth feature information of each of the multiple neighboring points comprises:
performing dimension extension on the fifth feature information of each of the multiple neighboring points respectively, to obtain sixth feature information of each of the multiple neighboring points; and
determining the correlative feature information of the respective data point based on the sixth feature information of each of the multiple neighboring points.

9. The method of claim 1, further comprising:
acquiring third point cloud data;
complementing the third point cloud data to obtain complete fourth point cloud data; and
merging the third point cloud data and the fourth point cloud data to generate the first point cloud data.

10. The method of claim 9, wherein merging the third point cloud data and the fourth point cloud data to generate the first point cloud data comprises:
merging the third point cloud data and the fourth point cloud data to obtain input point cloud data;
acquiring starting feature information of each of multiple data points of the input point cloud data; and
performing at least one of linear transformation or nonlinear transformation on the starting feature information of each of the multiple data points to obtain the first point cloud data.

11. The method of claim 10, wherein performing point cloud data reconstruction based on the first target feature information of each of the multiple data points to obtain the second point cloud data comprises:
determining the first target feature information of the respective data point as second target feature information of the respective data point, or, performing at least one of linear transformation or nonlinear transformation on the first target feature information of the respective data point to determine the second target feature information of the respective data point;
merging the second target feature information of the respective data point and the starting feature information of the respective data point to obtain third target feature information of the respective data point; and
performing point cloud data reconstruction based on the third target feature information of each of the multiple data points to obtain the second point cloud data.

12. The method of claim 1, wherein the initial feature information of each of the multiple neighboring points comprises initial feature information of at least two groups of neighboring points, each group of neighboring points comprise multiple neighboring points, and any two groups of neighboring points in the at least two groups of neighboring points have different numbers of neighboring points;
wherein determining the correlation degree information between the respective data point and the multiple neighboring points based on the initial feature information of the respective data point and the initial feature information of each of the multiple neighboring points comprises: for each group of neighboring points corresponding to the respective data point, determining correlation degree information between the respective data point and the group of neighboring points based on the initial feature information of the respective data point and the initial feature information of the group of neighboring points; and
wherein determining the first target feature information of the respective data point based on the correlation degree information between the respective data point and the multiple neighboring points comprises: determining the first target feature information of the respective data point based on the correlation degree information between the respective data point and each group of neighboring points in the at least two groups of neighboring points.

13. An electronic device, comprising a memory and a processor, wherein
the memory stores a computer program capable of running in the processor; and
the processor is configured to execute the computer program to:
for each of multiple data points of first point cloud data, acquire initial feature information of a respective one of the multiple data points of the first point cloud data and initial feature information of each of multiple neighboring points of the respective data point taken as a center point;
determine correlation degree information between the respective data point and the multiple neighboring points based on the initial feature information of the respective data point and the initial feature information of the multiple neighboring points;
determine first target feature information of the respective data point based on the correlation degree information between the respective data point and the multiple neighboring points; and
perform point cloud data reconstruction based on the first target feature information of each of the multiple data points to obtain second point cloud data.

14. The electronic device of claim 13, wherein in determining the correlation degree information between the respective data point and the multiple neighboring points based on the initial feature information of the respective data point and the initial feature information of each of the multiple neighboring points, the processor is configured to:
perform at least one of linear transformation or nonlinear transformation on the initial feature information of the respective data point and the initial feature information of each of the multiple neighboring points respectively to obtain first feature information of the respective data point and first feature information of each of the multiple neighboring points; and
determine the correlation degree information between the respective data point and the multiple neighboring points based on the first feature information of the respective data point and the first feature information of each of the multiple neighboring points.

15. The electronic device of claim 14, wherein in performing at least one of linear transformation or nonlinear transformation on the initial feature information of the respective data point and the initial feature information of each of the multiple neighboring points respectively to obtain the first feature information of the respective data point and the first feature information of each of the multiple neighboring points, the processor is configured to:
perform dimension extension on the initial feature information of the respective data point to obtain second feature information of the respective data point;
perform dimension compression on the second feature information of the respective data point to obtain the first feature information of the respective data point, a dimension of the first feature information of the respective data point being larger than a dimension of the initial feature information of the respective data point;
perform dimension extension on the initial feature information of each of the multiple neighboring points to obtain second feature information of each of the multiple neighboring points; and
perform dimension compression on the second feature information of each of the multiple neighboring points to obtain the first feature information of each of the multiple neighboring points, a dimension of the first feature information of each of the multiple neighboring points being larger than a dimension of the initial feature information of each of the multiple neighboring points.

16. The electronic device of claim 13, wherein the processor is configured to:
determine correlative feature information of the respective data point based on the correlation degree information between the respective data point and the multiple neighboring points; and
merge the correlative feature information of the respective data point and the initial feature information of the respective data point, to obtain the first target feature information of the respective data point.

17. The electronic device of claim 16, wherein in determining the correlative feature information of the respective data point based on the correlation degree information between the respective data point and the multiple neighboring points, the processor is configured to:
perform at least one of linear transformation or nonlinear transformation on the initial feature information of each of the multiple neighboring points respectively, to obtain third feature information of each of the multiple neighboring points; and
determine the correlative feature information of the respective data point based on the correlation degree information between the respective data point and the multiple neighboring points and the third feature information of each of the multiple neighboring points.

18. The electronic device of claim 17, wherein in performing at least one of linear transformation or nonlinear transformation on the initial feature information of each of the multiple neighboring points to obtain the third feature information of each of the multiple neighboring points, the processor is configured to:
perform dimension extension on the initial feature information of each of the multiple neighboring points respectively, to obtain fourth feature information of each of the multiple neighboring points; and
perform dimension compression on the fourth feature information of each of the multiple neighboring points respectively, to obtain the third feature information of each of the multiple neighboring points, a dimension of the third feature information of each of the multiple neighboring points being larger than the dimension of the initial feature information of each of the multiple neighboring points.

19. The electronic device of claim 17, wherein in determining the correlative feature information of the respective data point based on the correlation degree information between the respective data point and each of the multiple neighboring points and the third feature information of each of the multiple neighboring points, the processor is configured to:
aggregate the correlation degree information and the third feature information of each of the multiple neighboring points, to obtain fifth feature information of each of the multiple neighboring points; and
determine the correlative feature information of the respective data point based on the fifth feature information of each of the multiple neighboring points.

20. A non-transitory computer-readable storage medium coupled to at least one processor and storing programming instructions for execution by the at least one processor to:
for each of multiple data points of first point cloud data, acquire initial feature information of a respective one of the multiple data points of first point cloud data and initial feature information of each of multiple neighboring points of the respective data point taken as a center point;
determine correlation degree information between the respective data point and the multiple neighboring points based on the initial feature information of the respective data point and the initial feature information of each of the multiple neighboring points;
determine first target feature information of the respective data point based on the correlation degree information between the respective data point and the multiple neighboring points; and
performing point cloud data reconstruction based on the first target feature information of each of the multiple data points, to obtain second point cloud data.
